(19) United States
(12) Patent Application Publication
(10) Pub. No.: US 2008/0126092 A1
(43) Pub. Date: May 29, 2008

(54) Dictionary Data Generation Apparatus And Electronic Apparatus

(75) Inventors: Yoshihiro Kawazoe, Saitama (JP); Takehiko Shioda, Saitama (JP)

Correspondence Address: SUGHRUE MION, PLLC, 2100 PENNSYLVANIA AVENUE, N.W., SUITE 800, WASHINGTON, DC, 20037, US

(73) Assignee: PIONEER CORPORATION, Tokyo (JP)

(21) Appl. No.: 11/817,276

(22) PCT Filed: Feb. 22, 2006
(86) PCT No.: PCT/JP2006/303192

§ 371 Date: Nov. 14, 2007

(30) Foreign Application Priority Data
Feb. 28, 2005 (JP) 2005-054128

(51) Int. Cl. G06F 17/21; G10L 21/00

(52) U.S. Cl. 704/246; 704/275; 704/E15.04

(57) ABSTRACT

It is possible to realize a reliable audio recognition in use of dictionary data for audio recognition while reducing the data amount of the dictionary data. An information recording and reproducing apparatus RP acquires text data indicating each program title from EPG data, sets up a keyword within a range of number of characters “N” enabled to be displayed in a display column in a program list from each text data thus acquired, generates feature quantity pattern indicating feature quantity of voice corresponding to each keyword, and associates the feature quantity pattern with text data for specifying a program title to generate dictionary data. Furthermore, when displaying a program list, keyword portion is highlighted to show a user content of the keyword.

### TECHNICAL FIELD

The present invention relates to a technical field of recognizing an input command of a user from voice uttered by the user.

### BACKGROUND ART

So far, among an electronic apparatus such as a DVD recorder or a navigation apparatus, there exist some apparatuses which mount a so-called voice recognition apparatus for enabling a user to input various kinds of command (that is, execution command to the electronic apparatus) by uttering voice. In such a voice recognition apparatus, feature quantity pattern of voice corresponding to a keyword indicative of each command (for example, feature quantity pattern indicated by hidden Markov model) is compiled as a database (hereafter, this data is referred to as “dictionary data”), it is carried out to match the feature quantity pattern in the dictionary data with feature quantity corresponding to voice utterance of a user, and a command corresponding to the voice utterance of the user is specified. Moreover, in recent years, a television receiver having a function to specify a program selected by a user by generating the above-mentioned dictionary data in use of text data such as program title, included in electric program guide (EPG) broadcasted in use of free bandwidth in various broadcast format such as terrestrial digital broadcasting or BS digital broadcasting and by using the dictionary data thus generated has been proposed (vide Patent Document 1).

### Patent Document 1: Japanese Unexamined Patent Publication No. 2001-309256

### DISCLOSURE OF THE INVENTION

### Problem to be Solved by the Invention

Meanwhile, in an invention described in the above Patent Document 1, a method of setting up a plurality of keywords for one program title and of generating a feature quantity pattern of voice for each keyword is adopted. Therefore, there occur not only significant increment of processing amount for generation of dictionary data, but also substantial expansion of dictionary data, thereby loosing practicality. On the other hand, from a viewpoint for reducing data quantity of dictionary data, it is possible to allocate a simple keyword to each command and cause a user to utter the keyword. However, according to this method, a user cannot understand what utterance of keyword results in what command input, and there is a possibility that command input becomes impossible.

The present invention is made in consideration of the above circumstances and object of the present invention is for example, to provide a dictionary data generation apparatus, a dictionary data generation method, and an electronic apparatus and control method thereof, a dictionary data generation program, a processing program and information memory medium recording these programs for realizing assured voice recognition even when the dictionary data are used while reducing data quantity for voice recognition.

### Means for Solving Problem

In a first aspect of the invention for solving the above problem, a dictionary data generation apparatus according to Claim 1 is a dictionary data generation apparatus for generating dictionary data for voice recognition used in a voice recognition apparatus for recognizing an input command by a user on the basis of voice uttered by the user including:

an acquisition means for acquiring text data corresponding to the command;

a set-up means for extracting a portion of string out of the text data thus acquired and setting up the string as a keyword;

a generation means for generating the dictionary data by generating feature quantity data indicative of feature quantity of voice corresponding to the keyword thus set up and by associating content data for specifying content to be processes in correspondence with the command with the feature quantity data; and

a specification means for specifying number of characters in the keyword enabled to be display with a display apparatus for displaying the keyword,

wherein the set-up means sets up the keyword within a range of number of characters, specified with the specification means.

Further, in another aspect of the present invention, an electronic apparatus according to Claim 6 is an electronic apparatus including a voice recognition apparatus for recognizing input command from a user on the basis of voice uttered by the user including:

a record means for recording dictionary data associating feature quantity data indicative of feature quantity of a voice corresponding to a keyword, set up in a portion of the string corresponding to the command and content data for specifying content of processing corresponding to the command;

an input means for inputting voice uttered by the user;

a voice recognition means for specifying an input command corresponding to the uttered voice on the basis of the dictionary data thus recorded;

an execution means for executing process corresponding to the input command thus specified on the basis of the content data; and

a display control means for generating display data for displaying a keyword to be uttered by the user and providing it with a display apparatus.

Furthermore, in another aspect of the present invention, a dictionary data generation method according to Claim 12 is a dictionary data generation method for generating dictionary data for voice recognition, used in a voice recognition apparatus to recognize input command by a user on the basis of a voice uttered by the user, including:

an acquisition step of acquiring text data corresponding to the command;

a specification step of specifying number of characters of the keyword enabled to be displayed on a display apparatus for displaying the keyword for voice recognition;

a set-up step of extracting a portion of a string of text data thus acquired within a range of number of characters thus specified and setting up the string as the keyword; and

a generation step of generating the dictionary data by generating feature quantity data indicative of feature quantity of a voice corresponding to the keyword thus set up, and generating the dictionary data by associating content data for specifying content of process corresponding to the command with the feature quantity data.

Furthermore, in another aspect of the present invention, a control method of an electronic apparatus according to Claim 13 is a control method of an electronic apparatus including a voice recognition apparatus for recognizing an input command corresponding to a voice uttered by a user in use of dictionary data, associating feature quantity data indicative of feature quantity of voice corresponding to a key word set up in a portion of a string corresponding to the command with content data for specifying a content of process corresponding to the command, including:

a display step of generating display data for displaying a keyword to be uttered by the user and supplying these to a display apparatus;

a voice recognition step of specifying an input command corresponding to the voice uttered on the basis of the dictionary data in a case where the voice uttered by the user is inputted in accordance with screen image displayed on the display apparatus; and

an execution step of carrying out a process corresponding to the input command thus specified on the basis of the content data.

Furthermore, in another aspect of the present invention, a dictionary data generation program according to Claim 13 is a dictionary data generation program for generating dictionary data for voice recognition, used in a voice recognition apparatus which recognizes an input command by a user on the basis of a voice uttered by the user using a computer, comprising:

an acquisition means for acquiring text data corresponding to the command;

a specification means for specifying number of characters of a keyword for voice recognition, which can be displayed by a display apparatus for displaying the keyword;

a set-up means for extracting a part of string within a range of number of characters thus specified out of each text data thus acquired and setting up the string as the keyword; and

a generation means for generating feature quantity data indicative of feature quantity of a voice corresponding to the keyword thus set up and the dictionary data by associating content data for specifying content of process corresponding to the command with the feature quantity data.

Furthermore, according to another aspect of the present invention, a processing program according to Claim 15 is a processing program for executing a process in a computer including a record means for recording dictionary data associating feature quantity data indicative of feature quantity data corresponding to a keyword set up in a portion of a string corresponding to a command and content data for specifying content of process corresponding to the command;

and a voice recognition apparatus for recognizing an input command corresponding to a voice uttered by a user in use of the dictionary data, which causes the computer to function as:

a display means for generating display data for displaying a keyword to be uttered by a user on the basis of the dictionary data and supplying it to the display apparatus;

a voice recognition means for specifying an input command corresponding to the voice uttered on the basis of the dictionary data in a case where the voice uttered by the user is inputted in accordance with a screen image displayed on the display apparatus; and

an execution means for executing a process corresponding to the input command thus specified on the basis of the content data.

Furthermore, according to another aspect of the present invention, an information recording medium according to Claim 16 is an information recording medium having the dictionary data generation program according to claim 14 recorded on it.

Furthermore, in another aspect of the present invention, an information recording medium according to Claim 17 is an information recording medium having the processing program according to Claim 15 recorded on it.

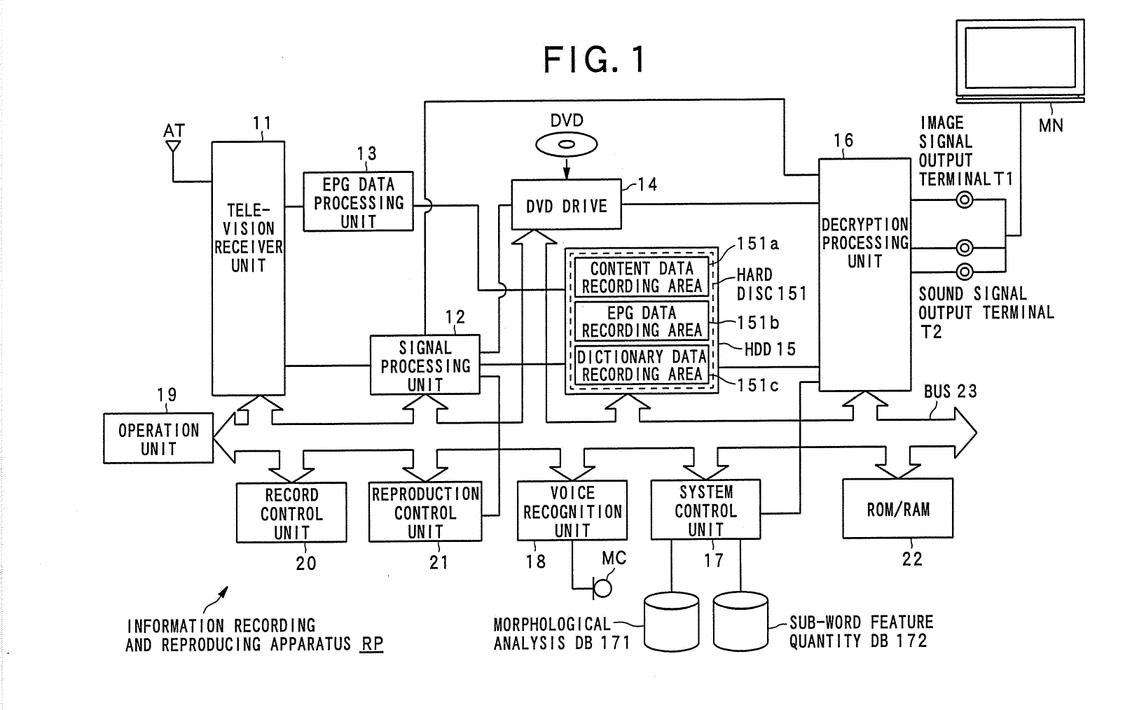

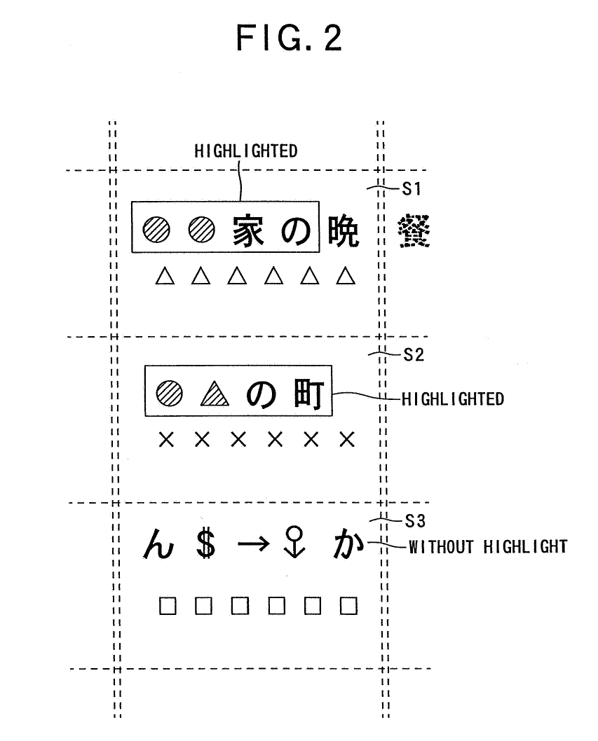

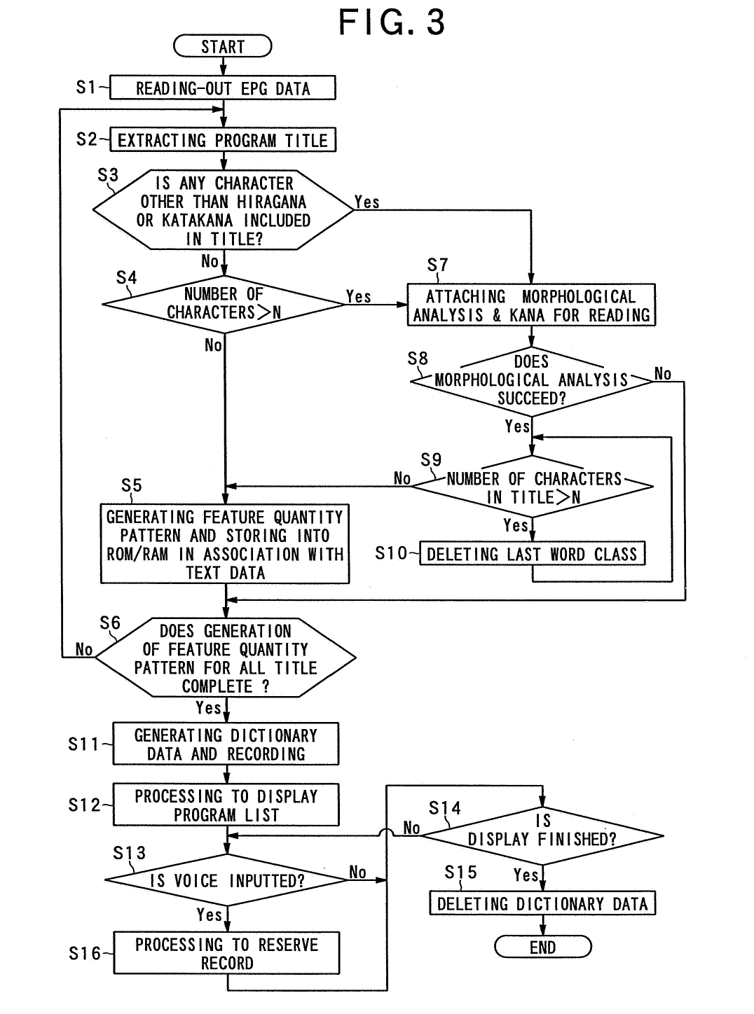

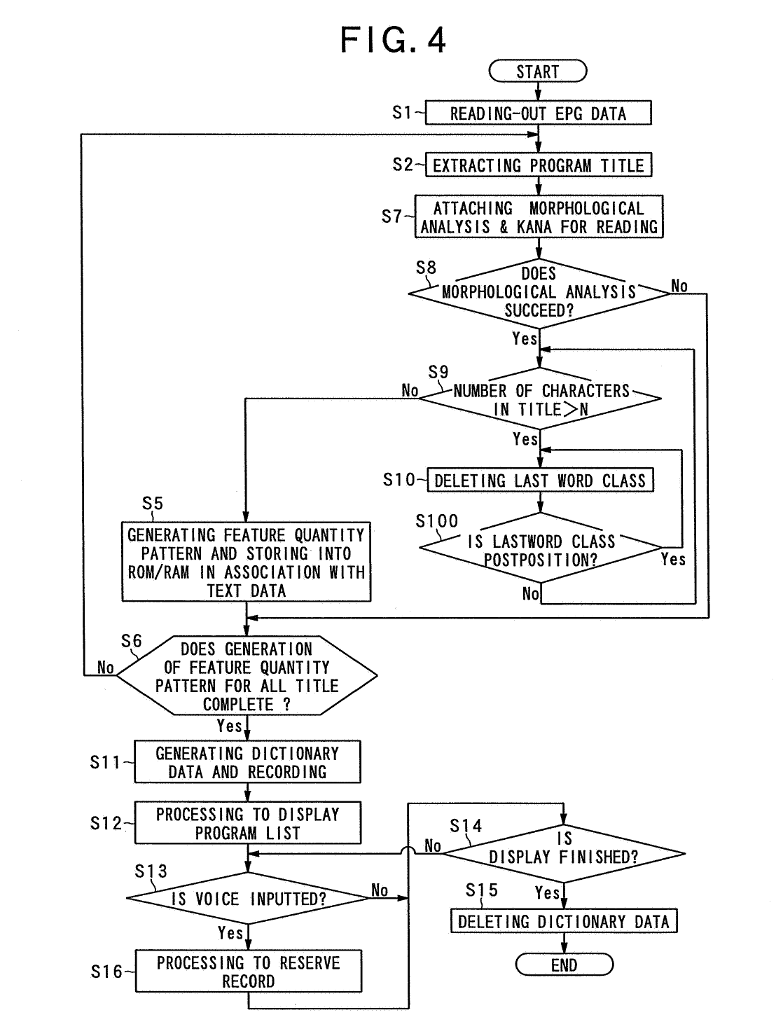

### BRIEF DESCRIPTION OF THE DRAWINGS

[FIG. 1] A block diagram for showing configuration of an information recording and reproducing apparatus RP in the present embodiment.

[FIG. 2] A diagram for conceptually showing relationship between a display column of a program list displayed on a monitor MN and a number of characters which can be displayed on the display column.

[FIG. 3] A flowchart for showing process executed when a system control unit 17 displays a program list in the present embodiment.

[FIG. 4] A flowchart for showing process executed when a system control unit 17 displays a program list in a second modified example.

### EXPLANATION ON NUMERICAL REFERENCES

RP: Information Recording and Reproducing Apparatus
11: Television Receiver Unit
12: Signal Processing Unit
13: EPG data Processing Unit
14: DVD Drive
15: Hard Disc
16: Decryption Processing Unit
17: System Control Unit
18: Voice Recognition Unit
19: Operation Unit
20: Record Control Unit
21: Reproduction Control Unit
22: ROM/RAM

### BEST MODES FOR CARRYING OUT THE INVENTION

### [1] Embodiment

### 1.1 Configuration of Embodiment

Hereafter, with reference to FIG. 1, a block diagram for showing configuration of an information recording and reproducing apparatus RP according to the present embodiment, embodiments of the present application will be described. Note that the embodiments described below are an embodiment of a case where the present application is applied to a so-called hard disc/DVD recorder, including a hard disc drive (hereinafter referred to as an “HDD”) and a DVD drive which perform recording and reading of data. Further, hereinafter a “broadcast program” represents content provided from each broadcast station through broadcast wave.

First, as shown in the figure, the information recording and reproducing apparatus RP according to the present application includes a TV receiver unit 11, a signal processing unit 12, an EPG data processing unit 13, a DVD drive 14, an HDD 15, a decryption processing unit 16, a system control unit 17, a voice recognition unit 18, an operation unit 19, a record control unit 20, a reproduction control unit 21, a ROM/RAM 22, and a bus 23 for connecting the elements each other. It roughly demonstrates the following functions.

(a) Record and reproduce function to receive broadcast wave corresponding to terrestrial analog broadcasting, terrestrial digital broadcasting, or the like by the TV receiver unit 11 and to record content data corresponding to the broadcast program in a DVD or a hard disc 151 and, on the other hand, to reproduce content data recorded on a DVD or the hard disc 151.
(b) Broadcast program display function to extract EPG data included in broadcast wave received by the TV receiver unit 11 and to cause a monitor MN to display a program list on the basis of the EPG data.

Here, as an characteristic issue, the information recording and reproducing apparatus RP extracts text data indicative of a program title from EPG data subjected to display, generates dictionary data for voice recognition using the title as a keyword (for voice recognition) (specifically, data respectively associating keywords with feature quantity patterns), and at the same time, carries out voice recognition by use of the dictionary to specify a program title corresponding to voice uttered by a user and record reservation processing of the broadcast program (“command” in “scope of claims” corresponds to, for example, execution command of such the processing).

Although specific content of the feature quantity pattern can be arbitrarily determined, for detailed explanation in the present embodiment, “feature quantity pattern” means data indicative of feature quantity pattern of voice indicated by HMM (statistical signal model expressing transition state of voice, defined by hidden Markov model). Moreover, although specific generation method of dictionary data can be arbitrarily determined, in the present embodiment, dictionary data is generated by generating feature quantity pattern corresponding to a program title by performing morphological analysis (that is, processing to divide a sentence written in a natural language into strings of morpheme such as word classes (including readings in kana and the same is applied hereinafter)) and cases where other methods are used will be described in modified examples.

Here, there are two concerns to be noted when demonstrating such function.

First one is that there is a possibility that among titles of programs included in EPG data, there may exist a title which cannot be morphologically analyzed and when such the situation occurs, a feature quantity pattern for a program title cannot be generated and therefore it is impossible to perform voice recognition of the program title. When such the situation occurs, a program title recognizable by voice and program title unrecognizable by voice are mixed in one program list, and when no countermeasure is taken, convenience for a user is deteriorated. Therefore, from a view point of enhancing convenience for the user, it is desirable to display the program titles while distinguishing between the program title recognizable by voice and the program title unrecognizable by voice.

The other concern is that when a program list is displayed, there is limitation in space for displaying the program list corresponding to each time slot. Therefore, there may be a case where a long program title cannot be displayed completely in the display column (for example, refer to FIG. 2). In such a case, when feature quantity pattern is generated using the entirety of the program title as a keyword, a user cannot pick up the entirety of the title (that is, a keyword for voice recognition) from the program list and there may occur a situation that the user cannot determine how to utter. Moreover, when a plurality of keywords are set up for one program title, it is possible to specify a program title when the user utters only a part of the program title. However, according to such the method, data quantity of dictionary data becomes tremendous.

From the above viewpoints, the present embodiment employs methods of (a) highlighting keyword portions which can be used for voice recognition on the program list, (b) generating a keyword for voice recognition within a range of number of characters enabled to display as a program title, which is unable to display in a display column in the program list, and highlighting the keyword only. Thus, convenience for a user of correctly uttering keywords is assured.

For example, in an example shown in FIG. 2, a case is assumed where characters as many as up to five can be displayed on display columns S1 to S3. In this case, for example, since an entire sentence of program title of “▴ [symbol] (four characters)” can be displayed, the information recording and reproducing apparatus RP uses the entire sentence of the program title as the keyword, feature quantity pattern is produced, and the entire program title is highlighted in the program list. On the other hand, in case of “ [symbol] (six characters)” where the entire program title cannot be displayed in the display columns, the information recording and reproducing apparatus RP sets up a character string of “ [symbol] as a keyword, obtained by deleting the last word class of [symbol] from the word classes (i.e. morphemes) configuring the program title “ [symbol] , and at the same time highlights only a portion of “ [symbol] in displaying the program list. Moreover, in case a title is not established as a word class like “ζ [symbol] →♂ [symbol] or a program title includes an unknown proper noun, or a program title is just a row of words in inconformity with grammar, it is impossible to generate feature quantity pattern because morphological analysis cannot be performed, and therefore the information recording and reproducing apparatus RP displays the program title without highlighting it to thereby present a user with impossibility of recognition.

A method of highlighting keyword portion in the program list is arbitrary determined, and for example (Display Method 1) color of the keyword portion may be changed, (Display Method 2) font of character of the portion may be changed, (Display Method 3) the characters may be displayed in bold, or (Display Method 4) character size may be changed. Moreover, (Display Method 5) the keyword portion may be underlined, (Display Method 6) may be boxed off, (Display Method 7) may be caused to blink, or (Display Method 8) may be reversely displayed.

Hereafter, configuration of the information recording and reproducing apparatus RP according to the present embodiment is described for realizing such the functions.

First, the TV receiver unit 11 is a tuner for analog broadcasting such as terrestrial analog broadcasting and digital broadcasting such as terrestrial digital broadcasting, communication satellite broadcasting, and broadcasting satellite digital broadcasting and receives broadcast wave through an antenna AT. Then the TV receiver unit 11, for example, when broadcast wave to be received is analog, demodulates the broadcast wave into video signal and audio signal for TV (hereinafter referred to as “TV signal”) and provides the signal to the signal processing unit 12 and the EPG data processing unit 13. Meanwhile, when the broadcast wave to be received is digital, the TV receiver unit 11 extracts transport stream included in the broadcast wave thus received and provides it to the signal processing unit 12 and the EPG data processing unit 13.

Under the control by the record control unit 20, the signal processing unit 12 provides a predetermined processing to the signal supplied from the TV receiver unit 11. For example, when TV signal corresponding to analog broadcast is provided from the TV receiver unit 11, the signal processing unit 12 converts the signal into predetermined form of digital data (that is, content data) by providing predetermined signal processing and A/D conversion with the TV signal. At this time, the signal processing unit 12 compresses the digital data into, for example, moving picture coding experts group (MPEG) format to generate a program stream, and provides the program stream thus generated to the DVD drive 14, the HDD 15, or the decryption processing unit 16. On the contrary, when a transport stream corresponding to digital broadcast is supplied from the TV receiver unit 11, the signal processing unit 12 converts content data included in the stream into program stream, and thereafter supplies the program stream to the DVD drive 14, the HDD 15, or the decryption processing unit 16.

Under the control of the system control unit 17, the EPG data processing unit 13 extracts EPG data, included in the signal supplied from the TV receiver unit 11, and supplies the EPG data thus extracted to the HDD 15. For example, when TV signal corresponding to analog broadcasting is provided, the EPG data processing unit 13 extracts EPG data included in VBI of the TV signal thus provided and provides the data to the HDD 15. Moreover, when transport stream corresponding to digital broadcast is supplied, the EPG data processing unit 13 extracts EPG data included in the stream and supply the data to the HDD 15.

The DVD drive 14 records and reproduces data on and from a mounted DVD and the HDD 15 records and reproduces data onto and from the hard disc 151. In the hard disc 151 of the HDD 15, a content data recording area 151a to record content data corresponding to a broadcast program is provided, and at the same time, an EPG data recording area 151b to record EPG data provided by the EPG data processing unit 13 and a dictionary data recording area 151c to record dictionary data generated by the information recording and reproducing apparatus RP are provided.

Subsequently, the decryption processing unit 16 divides, for example, content data of a program stream type, provided from the signal processing unit 12 and read out of a DVD and a hard disc 151, into audio data and image data and also decodes each of these data. Then, the decryption unit 16 converts the content data thus decoded into NTSC signal and outputs image signal and audio signal thus converted to the monitor MN through an image signal output terminal T1 and an audio signal output terminal T2. When a decoder or the like is mounted on the monitor MN, it is unnecessary to perform decode or the like by the signal processing unit 15 and the content data may be outputted to the monitor as is.

The system control unit 17 is configured mainly with a central processing unit (CPU) and includes various kinds of I/O ports such as a key input port to holistically control the entire function of the information recording and reproducing apparatus RP. In controlling as such, the system control unit 17 uses control information or a control program recorded in the ROM/RAM 22 and also uses the ROM/RAM 22 as a work area.

For example, the system control unit 17 controls the record control unit 20 and reproduction control unit 21 according to input operation of the operation unit 19 to cause a DVD or the hard disc 151 record or reproduce data.

Furthermore, for example, the system control unit 17 controls the EPG data processing unit 13 at a predetermined timing to cause the EPG data processing unit 13 to extract EPG data included in broadcast wave and by use of the EPG data thus extracted, updates EPG data recorded in the EPG data recording area 151b. Timing for updating the EPG data can be arbitrarily determined and, for example, under the condition that EPG data are broadcasted at a predetermined time everyday, the time may be recorded in ROM/RAM 22 and the EPG data may be updated at this time.

Furthermore, the system control unit 17 generates the above-mentioned dictionary data for voice recognition before displaying a program list based on EPG data, recorded on the EPG data recording area 151b, records the dictionary data thus generated in the dictionary data recording area 151c, and when a program list based on the EPG data is displayed, causes keyword portions to be highlighted in the program list. To realize generation function of such dictionary data, in the present embodiment, the system control unit 17 includes a morphological analysis database (hereinafter, database will be referred to as “DB”) 171 and a sub-word feature quantity DB 172. Both the DBs 171 and 172 may be physically realized by providing predetermined recording areas in the hard disc 151.

In this, the morphological analysis DB 171 is a DB in which data for performing morphological analysis to text data extracted from EPG data is stored, and for example data or the like corresponding to Japanese dictionary for decomposition of word classes and allocation of kana for reading to each word class is stored. On the other hand, the sub-word feature quantity DB 172 is a DB, in which HMM feature quantity pattern corresponding to a sub-word for each syllable or phoneme, or for a portion of voice expressed by a combination of a plurality of syllables or phonemes (hereafter, referred to as “sub-word”) is stored.

When dictionary data are generated in the present embodiment, the system control unit 17 executes morphological analysis to text data corresponding to each program title by use of data stored in the morphological analysis DB 171, and at the same time reads out feature quantity pattern corresponding to sub-words configuring a program title acquired by the processing from the sub-word feature quantity DB 172. Then by combining the read out feature quantity patterns, the system control unit 17 generates feature quantity pattern corresponding to the program title (or a portion thereof). Although timing to erase dictionary data generated by the system control unit 17 and saved in the hard disc 151 can be arbitrary determined, since the dictionary data cannot be used due to update or the like of EPG data, in the present embodiment, following explanation is made on an assumption that dictionary data are generated every time a program list is displayed, and when the program list is completely displayed dictionary data saved in the hard disc 151 is deleted.

Subsequently, in the audio recognition unit 18, a microphone MC for collecting voice uttered by a user is provided. When uttered voice by a user is inputted into this microphone MC, the voice recognition unit 18 extracts feature quantity pattern of the voice by a predetermined interval and calculates matching ratio (that is, similarity) between the pattern and feature quantity pattern in dictionary data. Then, the voice recognition unit 18 accumulates similarity of all the inputted voices and calculates it and outputs a keyword having the highest similarity, obtained as a result of the calculation (that is, program title or a portion thereof, to the system control unit 17 as a recognition result. As a result EPG data is searched on the basis of the program title and a broadcast program to be recorded is specified in the system control unit 17.

Note that a specific voice recognition method adopted in the voice recognition unit 18 is arbitrary. For example, when a conventionally used method such as keyword spotting (that is, a method by which keyword portion is extracted for voice recognition even when an unnecessary words is attached to a keyword for voice recognition) or large vocabulary continuous speech recognition (dictation) is adopted, even when a user adds an unnecessary word (hereinafter referred to as “unnecessary word”) when uttering a keyword (for example, in a case where a keyword is already set using a portion of a program title, but a user who knows the title utters the whole of the program title), it is possible to extract the keyword included in the uttered voice of a user without fail to realize voice recognition.

The operation unit 19 includes a remote control apparatus having various keys such as number keys and light receiving portion for receiving light transmitted from the remote control apparatus and outputs control signal corresponding to input operation by a user to the system control unit 17 via the bus 23. The record control unit 20, under the control by the system control unit 17, controls recording of content data to a DVD or the hard disc 151 and reproduction control unit 21, under the control by the system control unit 17, controls reproduction of content data recorded in a DVD or the hard disc 151.

### 1.2 Operation of Embodiment

Next, with reference to FIG. 3, operation of the information recording and reproducing apparatus RP according to the present embodiment will be described. Note that record operation and reproduction operation of content date by a DVD or the hard disc 151 is not different from conventional hard disc/DVD player. Therefore, in the following, only processing performed when a program list is displayed in the information recording and reproducing apparatus RP will be explained. Moreover, in the following explanation, it is assumed that EPG data are already recorded in the EPG data recording area of the hard disc 151.

First, when power switch of the information recording and reproducing apparatus RP is on, a user performs input operation to a remote control apparatus (not shown) so that a program list is displayed. Then, in the information recording and reproducing apparatus RP, the system control unit 17 starts processing shown in FIG. 3 upon this input operation as a trigger.

In this processing, the system control unit 17 first outputs control signal to the HDD 15, causes EPG data corresponding to the program list which is a display target to be read out from the EPG data recording area 151b (Step S1) and searches the EPG data thus read out to extract text data corresponding to a program title included in the EPG data (Step S2). Subsequently, the system control unit 17 judges whether any character other than hiragana and katakana is included in the text data thus extracted (Step S3), and when it is judged “no” in this judgment, it is judged whether or not the number of characters of the program title exceeds number of characters “N”, which can be displayed in a display column of the program list (Step S4). In this occasion it is possible to adopt a structure that a method of determining the number of characters “N” enabled to be displayed is arbitrary determined, for example the data indicative of the number of characters enabled to be displayed is recorded into the ROM/RAM 22 in advance and the number “N” is specified on the basis of the data.

Then, in a case where it is judged “no” in this judgment, i.e. when all strings corresponding to the text data can be displayed in display columns of program list, the system control unit 17 reads out feature quantity pattern corresponding to each kana character included in the text data from the sub-word feature quantity DB 172, generates feature quantity pattern corresponding to the string (i.e. a program title to be a keyword), and saves the feature quantity pattern in association with text data corresponding to keyword portion (i.e. text data corresponding to all of the program title, or a portion thereof) into ROM/RAM 22 (Step S5). The text data associated with feature quantity pattern is used to specify an input command (in the present embodiment, recording reservation) when voice recognition is carried out and corresponds to for example “content data” in “scope of claims”.

After finishing the Step S5, the system control unit 17 judges whether generation of feature quantity pattern corresponding to all the program titles in the program list is completed or not (Step S6) and when it is judged “yes” in this judgment, the process moves to Step S11, but on the other hand, when it is judged “no”, the process returns back to Step S2.

Meanwhile, (1) when in a case where it is judged “yes” in Step S3, i.e. any character other than hiragana and katakana is included in a string corresponding to a program title, or (2) when it is judged “yes” in Step S4, in either case, the system control unit 17 shifts process to Step S7 and carries out morphological analysis on text data corresponding to a program title extracted from EPG data (Step S7). At this time, the system control unit 17 decomposes the string corresponding to the text data into portions of word classes on the basis of data stored in the morphological analysis DB 171, and at the same time performs processing to decide kana for reading corresponding to each word class thus decomposed.

Here, in a case where a string corresponding to a program title is not established as a word class as mentioned above (for example, “ζ [symbol] →♂ [symbol] in FIG. 2) or a program title is grammatically wrong, it is impossible to carries out morphological analysis on the string corresponding to the text data. Therefore, the system control unit 17 judges whether or not morphological analysis is succeeded in Step S7 and in a case where it is judged that the analysis failed (“no”), without performing processing in Steps S9, 10, and 5, shifts the processing to Step S6 and judges whether generation of dictionary data is completed or not.

On the other hand, when it is judged that morphological analysis is succeeded in Step S8, the system control unit 17 judges whether or not number of characters of the program title exceeds number of characters “N” enabled to display (Step S9). For example, in a case of an example shown in FIG. 2, since five characters can be displayed in a display column of program list, all characters of a program title “▴ [symbol] can be displayed. In such a case, the system control unit 17 judges “yes” in Step S9, generates feature quantity pattern corresponding to kana for reading out the program title on the basis of data, the sub-word feature quantity DB 172, the feature quantity pattern is stored in ROM/RAM 22 (Step S5) in association with text data corresponding to keyword portion and processing in Step S6 is executed.

On the other hand, as in a case of a program title such as “ [symbol] in the example of FIG. 2, when all the characters cannot be displayed in the display column, the system control unit 17 judges in Step S9 that number of characters of the program title exceeds number of characters “N” enable to be displayed (“yes”), deletes a portion of kana for reading corresponding to the last word class (that is, [symbol] from the program title (Step S10), and executes processing in Step S9 again. Then, the system control unit 17 repeats processes in Steps S9 and 10 to sequentially delete word classes forming the program title, and when the program title after deletion of word classes becomes equal to or lower than the number of characters “N” enabled to be displayed, it is judged “yes” in Step S9 and the process moves to Steps S5 and S6.

Subsequently, the system control unit 17 repeats the same processing and repeats processing in Steps S2 to 10 on text data corresponding to all the program titles included in EPG data read out. When text data corresponding to all the program titles and feature quantity patterns are stored in ROM/RAM 22, it is judged in Step S6 “yes” and the process moves to Step S11. In Step S11, the system control unit 17 generates dictionary data on the basis of feature quantity pattern stored in ROM/RAM 22 and text data corresponding to the portion of the keyword, and records the dictionary data thus generated in the dictionary data recording area 151c of the hard disc 151.

Next, the system control unit 17 generates data for displaying a program list on the basis of EPG data and provides the data thus generated with the decryption processing unit 16 (Step S12). At this time, the system control unit 17 extracts text data corresponding to keyword portion in dictionary data and generates data for displaying the program list so that among titles of programs corresponding to the text data, only strings corresponding to keyword portions are highlighted. As a result, on the monitor MN, as shown in FIG. 2, only keyword portions for voice recognition are highlighted and a user can understand which string in the program list should be uttered as voice. Moreover, when display processing of the program list ends, the system control unit 17 judges whether or not voice input of designating a program title is carried out by a user (Step S13), and when it is judged “no” in this judgment, the system control unit 17 judges whether or not the display is finished (Step S14). When it is judged “yes” in this Step S14, the system control unit 17 deletes dictionary data recorded in the hard disc 151 (Step S15) and finishes the process. On the other hand, when it is judged “no”, the system control unit 17 returns the processing to Step S13 and waits for manual input by a user.

Thus, when the system control unit 17 moves to an input waiting state, the audio recognition unit 19 simultaneously waits for input of voice utterance by a user. In this state, when a user inputs a keyword, for example, “ [symbol] by voice to the microphone MC, the voice recognition unit 18 carries out matching processing between the voice thus inputted and feature quantity pattern in dictionary data. Then, due to this matching processing, feature quantity pattern having similarity to the inputted voice is specified, text data of keyword portion described in association with the feature quantity pattern are extracted, and the text data thus extracted is outputted to the system control unit 17.

Meanwhile, when text data are supplied from the audio recognition unit 19, in the system control unit 17, judgment in Step S13 is changed to “yes” and after execution of process for record reservation of a broadcast program (Step S16), the process moves to Step S14. In Step S16, the system control unit 17 searches for EPG data on the basis of text data supplied from the audio recognition unit 19 and extracts data indicative of a broadcast channel and broadcast time, described in association with a program title corresponding to the text data. Then, the system control unit 17 saves the data thus extracted in ROM/RAM 22 and outputs control signal indicative of a channel to record to the record control unit 20 when the broadcast time comes. The record control unit 20 causes the TV receiver unit 11 to change the receiving bandwidth to thereby synchronize with the reserved channel on the basis of the control signal thus provided, causes the DVD drive or the HDD to start data record, and causes a DVD or the hard disc 151 to start to record data and content data, which corresponds to broadcast programs recording of which is reserved, in a sequential manner into a DVD or the hard disc 151.

Thus, the information recording and reproducing apparatus RP according to the present embodiment is configured to acquire text data indicating each program title from EPG data, set a keyword from each text data thus acquired within a range of number of characters “N” enabled to be displayed in a display column of a program list, generate feature quantity pattern indicative of feature quantity of voice corresponding to each keyword thus set, and generate dictionary data by associating the feature quantity pattern with text data for specifying a program title. According to this configuration, since dictionary data are generated while setting up a portion of a program title as a keyword, it is possible to reduce data amount of dictionary data used for voice recognition. Moreover, when the dictionary data are generated, since a keyword is set within a range of number of characters which can be displayed in a display column of a program list, it is possible to cause content of utterance of the keyword to be displayed in the display column of the program list without fail, and therefore possible to assured voice recognition when the dictionary data are used.

Further, in the above embodiment, it is constructed that when a portion of text data corresponding to a program title is extracted, a predetermined number of word classes are sequentially deleted from the bottom until number of characters of the title reaches the number of characters “N” enabled to be displayed. Therefore, number of characters of a keyword can be more assuredly deleted, and it is possible to realize voice recognition without fail.

Furthermore, in the above embodiment, since a keyword is displayed in a program list when the program list is displayed, it is possible for a user to surely recognize a keyword to be uttered by observing the program list. Therefore, it is possible to contribute on improvement in enhancing convenience for user and assuredness of voice recognition.

Especially, since it is adopted in the present embodiment, that a configuration including the above-mentioned display methods 1 to 8 for highlighting keywords, even when a program title including characters other than the keyword is displayed in the display column of the program list, it is possible to show a keyword to be uttered to a user without fail.

In the present embodiment, explanation is given to a case where the present invention is applied to an information recording and reproducing apparatus RP, which is the hard disc/DVD recorder. However, the present embodiment can be applied to an electronic apparatus such as a TV receiver having a PDP, a liquid crystal panel, an organic electro luminescent panel or the like equipped therein, and electronic apparatuses such as a personal computer and a car navigation apparatus.

In the above-mentioned embodiment, there is adopted a configuration that dictionary data are generated in use of EPG data. However, a type of data used in producing dictionary data is arbitrarily determined. As long as text data are included, any data are applicable. For example, it may be possible to generate dictionary data indicative of HTML (Hyper Text Markup Language) data corresponding to various page (a home page for ticket reservation or the like) on WWW (World Wide Web) and data showing restaurant menu. Furthermore, by making dictionary data based on DB for home delivery, it is possible to apply to a sound recognition apparatus used in accepting home delivery with phone or the like.

Furthermore, there is described in the above-mentioned embodiment that a case where recording reservation of a broadcast program is performed on the basis of voice utterance by a user. However, processing content carried out on the basis of voice utterance by a user (that is, content of processing corresponding to an execution command) can be arbitrarily determined, and for example it is possible to make a receiving channel being switched over.

In the above-mentioned embodiment, one keyword is set with respect to one program title and one feature quantity pattern corresponding to the keyword is generated. However, a plurality of keywords may be set with respect to one program title and feature quantity pattern may be generated with respect to each keyword. For example, in case of “ [symbol] , a program title shown in FIG. 2, three keywords such as “”, “ [symbol] , and “ [symbol] are set and feature quantity pattern with respect to each keyword is generated. By adopting such a method, it is possible to deal with fluctuation of utterance by a user and hence it is possible to enhance accuracy of voice recognition.

Furthermore, in the above-mentioned embodiment, an explanation is given on an assumption that there is a limit to number of characters to be displayed in a display column when a program list is displayed. However, even when there is no limit to the number of characters to be displayed, by generating feature quantity pattern by setting a portion of a program title as a keyword in a manner similar to the above, it becomes possible to carry out record reservation or the like by voice recognition without causing a user to utter the entire program title. Therefore, it is possible to enhance convenience for a user.

In the above-mentioned embodiment, a structure of displaying a program title in a mode of including portions other than a keyword portion. However, it is possible to display only a keyword in the program list.

Further, in the above-mentioned embodiment, an explanation is given of a case of the information recording and reproducing apparatus RP having both the DVD drive 14 and the HDD 15 equipped in it. However, it is possible for an information recording and reproducing apparatus RP having either of the DVD drive 14 or the HDD 15 equipped in it to execute the similar processing. However, in case of an electronic apparatus without mounting the HDD 15, since it is required to separately provide the morphological analysis DB 171, the sub-word feature quantity DB 172 and the recording area of EPG data, it is necessary to provide a flash memory or to mount a DVD-RW to the DVD drive 14 to record each of the above data on such the recording mediums.

In the present embodiment, a method by which EPG data is recorded in the hard disc 151 was adopted. However, in an environment where EPG data is broadcasted all the time, EPG data may be acquired on a real time basis and dictionary data may be generated on the basis of the EPG data.

Further, in the above-mentioned embodiment, every time a program list is displayed, dictionary data are generated, and voice recognition is carried out by use of the dictionary data. However, dictionary data corresponding to EPG data may be generated upon receipt of the EPG data, and processing such as recording of a program may be carried out by use of the dictionary data.

Further, in the above-mentioned embodiment, a configuration of setting up a keyword for voice recognition is adopted in the information recording and reproducing apparatus RP. However, it is possible to carry out morphological analysis in generating the EPG data and carries out broadcast when EPG data are generated by describing data indicating content of a keyword inside the EPG data from the start. In this case, in the information recording and reproducing apparatus RP, feature quantity pattern may be generated on the basis of the keyword and dictionary data may be generated on the basis of data indicating a keyword included in the feature quantity pattern and the EPG data and text data of a program title.

In the above-mentioned embodiment, when a keyword for voice recognition is extracted on the basis of a program title, kana for reading is allocated on the basis of data corresponding to Japanese dictionary stored in the morphological analysis DB 171 and feature quantity pattern is generated on the basis of the kana for reading. However, among titles of movie, there are many titles such as “□□man 2”. In this case, there may be a case where a user cannot determine pronunciation of the portion of “2” whether “two” or “ni”. Therefore, in such a case, a keyword may be determined excluding this “2”.

Furthermore, in the above-mentioned embodiment, dictionary data are generated with the information recording and reproducing apparatus RP and a program list is displayed by use of the dictionary data. However, a recording medium having a program for regulating generation processing of dictionary data or display processing of a program list recorded on it and a computer for reading the program out may be provided, and processing operation similar to the above may be carried out by making the computer read the program in.

### Modified Example of Embodiment

### (1) Modified Example 1

When a method according to the above-mentioned embodiment is adopted, there may be a case where an identical keyword is set for a plurality of programs depending on the value of number of characters “N” enabled to be displayed. For example, when it is assumed that the number of characters “N” enabled to be displayed is five characters, with respect to both of “News ( is a word class)” and “News ▴▴▴ (▴▴▴ is a word class)”, a keyword “news” is set (needless to say, when the value of “N” is large enough, possibility of occurring such a situation infinitely approaches to zero, and therefore adoption of the following method is unnecessary). As a countermeasure against such the situation, following methods can be adopted.

### <Countermeasure 1>

This countermeasure is a method to make a user to select by displaying candidates of the program titles which correspond to the keyword when voice is inputted, without adding change to the keyword. For example, in case of the above example, one same keyword “news” is set for both “News ” and “News ▴▴▴”. Then, when a user utters “news”, on the basis of this keyword, both “News ” and “News ▴▴▴” are extracted, both are displayed on the monitor MN as selection candidates, and a broadcast program selected by the user according to the display is selected as an object of record.

### <Countermeasure 2>

This countermeasure is a method of extending the number of characters set as a keyword until a difference between the keywords of both titles of programs is known. For example, in the above-mentioned example, both “News ” and “News ▴▴▴” become keywords which respectively correspond to broadcast programs. However, when this method is adopted, the entire keyword cannot be displayed in the display column of the program list. Therefore, when adopting this countermeasure, it is necessary to adopt a method to display the program title by reducing font size so that the entirety of the program title can be displayed in the display column.

### (2) Modified Example 2

In the above-mentioned embodiment, a method of carrying out morphological analysis is cases where (1) any character other than hiragana and katakana is included in a program title (when it is judged “yes” in Step S3) and (2) program title exceeds number of characters “N” enabled to be displayed (when it is judged “yes” in Step S4). However, without providing these judgment steps, morphological analysis may be uniformly carried out with respect to all the program titles (Step S7), and processes in Steps S8 to S10 may be executed.

Furthermore, in the above-mentioned embodiment, there is adopted a configuration in which no condition is set when a keyword is set. However, it is possible to set up a condition that, for example, last word class on the last position of the keyword should be any class other than a postposition (for example, noun or verb) may be set and the content of the condition thus set may be saved in the ROM/RAM 22 (hereinafter, data indicating this set condition will be referred to as “condition data”).

Content of processing in a case where a measure of setting up the above conditions and uniformly carrying out morphological analysis with respect to all the program titles is shown in FIG. 4. As shown in the figure, when such the method is adopted, after carrying out processing in Steps S1 and S2 of FIG. 3, processing in Steps S7 to S10 is executed. Furthermore, after Step S10, it is judged whether or not extracted keyword matches content of the set condition, specifically, it is judged whether not last word class is a postposition on the basis of condition data (Step S100). When it is judged “yes”, the process returns to Step S10, the postposition is deleted, and process in Step S100 is repeated. When this process is executed, for example, with respect to a keyword “ [symbol] shown in FIG. 2, since the keyword ends with a postposition [symbol] , this [symbol] is deleted and “” is set as a keyword.

Subsequently, processes in Steps S9, S10 and S100 are repeated, and when the keyword is the number of characters “N” enabled to be displayed or less, the processes in Steps S5, S6 and S11 in the above-mentioned FIG. 3 are carried out.

### (3) Modified Example 3

It is adopted in the above-mentioned embodiment a method of setting up a keyword by providing morphological analysis to text data corresponding to a program title by dividing the program title into a plurality of word classes and generating feature quantity pattern. However, it is also possible to set up a keyword using a method other than morphological analysis. For example, the following method is also applicable.

First, by the following method, a string having a predetermined number of characters is extracted from a program title.

(a) Case where Chinese Character is not included program title
(i) N number of characters are extracted from the beginning of title, or
(ii) N number of characters from the beginning and M number of characters from the end of title are extracted and combined.
(b) Case where Chinese Character is included in program title
(i) two or more consecutive Chinese characters are extracted, or
(ii) two or more consecutive Chinese Characters immediately before hiragana, or immediately after hiragana are extracted.

Subsequently, when a Chinese Character is included in the string thus extracted, reading of the Chinese Character is extracted from DB of Japanese dictionary or Chinese character dictionary (provided instead of morphological analysis DB 171). Then, feature quantity pattern corresponding to the kana character thus acquired is generated on the basis of data stored in the sub-word feature quantity DB 171. According to such a method, without performing morphological analysis, it is possible to generate feature quantity pattern by decomposing text data corresponding to a program title into word classes.

### (4) Modified Example 4

In the above-mentioned embodiment, a keyword is set up without considering meaning or content of keyword. However, there may be a case where as a result of extracting a portion of program title, for example, the keyword thus extracted matches an inappropriate word such as a word banned from being broadcasted. In such a case, content of the keyword may be changed by a method like deletion of the last word class of keyword.

1. A dictionary data generation apparatus for generating dictionary data for voice recognition used in a voice recognition apparatus for recognizing an input command by a user on the basis of voice uttered by the user comprising:
an acquisition device that acquires text data corresponding to the command;
a set-up device that extracts a portion of string out of the text data thus acquired and sets up the string as a keyword;
a generation device that generates the dictionary data by generating feature quantity data indicative of feature quantity of voice corresponding to the keyword thus set up and by associating content data for specifying content to be processed corresponding to the command with the feature quantity data; and
a specification device that specifies number of characters in the keyword enabled to be display with a display apparatus for displaying the keyword,
wherein the set-up device sets up the keyword within a range of number of characters, specified with the specification device.

2. The dictionary data generation apparatus according to claim 1, further comprising:
a receiving device that receives electronic program list information for displaying a program list of broadcast programs,
wherein the acquisition device acquires text data indicative of each broadcast program title from the electronic program list information thus received by the receiving device; and
the set-up device extracts a portion of the string out of the text data and sets up the portion of program title as the keyword.

3. The dictionary data generation apparatus according to claim 1,
wherein the set-up device extracts a portion of a string, which is a portion of the text data, out of the text data by deleting a predetermined number of word classes from the bottom of the string corresponding to the text data.

4. The dictionary data generation apparatus according to claim 1,
wherein the set-up device includes the condition data recording device for recording condition data indicative of a condition for extracting string in setting up, and
the set-up device extracts a portion of string out of the text data on the basis of both of number of characters specified by the specification device and the condition data.

5. The dictionary data generation apparatus according to claim 1,
wherein when the keyword is set up, the set-up device increases number of characters set up as a keyword in a case where a keyword made of a string same as the keyword thus set up is set up in correspondence with another command.

6. An electronic apparatus including a voice recognition apparatus for recognizing input command from a user on the basis of voice uttered by the user comprising:
a record device that records dictionary data associating feature quantity data indicative of feature quantity of a voice corresponding to a keyword, set up in a portion of the string corresponding to the command and content data for specifying content of processing corresponding to the command;
an input device that inputs voice uttered by the user;
a voice recognition device that specifies an input command corresponding to the uttered voice on the basis of the dictionary data thus recorded;
an execution device that executes process corresponding to the input command thus specified on the basis of the content data; and
a display control device that displays display data for displaying a keyword to be uttered by the user and providing it with a display apparatus,
wherein the keyword in the dictionary data is set up in a range of number of characters enabled to display for displaying the keyword, and
the display control device generates the display data in the range of number of characters enabled to display and supplies it to the display apparatus.

7. The electronic apparatus according to claim 6,
wherein the display control device highlights only a character portion corresponding to the keyword, included in a string in generating display data for displaying the string including as least the keyword, being a part of the string corresponding to the command.

8. The electronic apparatus according to claim 7,
wherein the display control device highlights by at least one of the following measures in highlighting:
(a) displaying by changing color of only a keyword portion,
(b) displaying by changing font of character of the keyword portion,
(c) displaying the characters of the keyword portion in bold,
(d) displaying by changing character size of the keyword portion,
(e) displaying character of the keyword portion by surrounding with frame,
(f) displaying by blinking character of the keyword portion, or
(g) displaying by reversing character the keyword portion.

9. The electronic apparatus according to claim 7, further comprising:
the receiving device that receives electronic program list information for displaying a program list of broadcast program,
wherein the record device records content data corresponding to a command specifying the broadcast program and the dictionary data associating the feature quantity data corresponding to keyword, which is set up at a portion of a string corresponding to the program, and
the display control device causes the display apparatus display the program list on the basis of the electronic program list information thus received, and highlight a keyword portion to be uttered by a user in displaying the program list on the basis of the dictionary data.

10. The electronic apparatus according to claim 9, further comprising a content data record device that records content data corresponding to the broadcast program,
wherein the receiving device receives the content data along with the electronic program list information, and
the execution device extracts at least one of broadcast channel and broadcast time, corresponding to the broadcast program designated by the content data corresponding to the input command thus specified out of the electronic program list information, and simultaneously carries out one of (a) record reservation of the content data corresponding to the broadcast program and (b) switch-over of receiving channel in the receiving device.

11. The electronic apparatus according to claim 6,
wherein the display control device further includes a selection screen display control device that causes the display device display a selection image provided for the user to select which command to be executed in a case where there exist a plurality of input commands, specified by the voice recognition device.

12. A dictionary data generation method for generating dictionary data for voice recognition, used in a voice recognition apparatus to recognize input command by a user on the basis of a voice uttered by the user, comprising:
an acquisition step of acquiring text data corresponding to the command;
a specification step of specifying number of characters of the keyword enabled to be displayed on a display apparatus for displaying the keyword for voice recognition;
a set-up step of extracting a portion of a string of text data thus acquired within a range of number of characters thus specified and setting up the string as the keyword; and
a generation step of generating the dictionary data by generating feature quantity data indicative of feature quantity of a voice corresponding to the keyword thus set up, and generating the dictionary data by associating content data for specifying content of process corresponding to the command with the feature quantity data.

13. A control method of an electronic apparatus including a voice recognition apparatus for recognizing an input command corresponding to a voice uttered by a user in use of dictionary data, associating feature quantity data indicative of feature quantity of voice corresponding to a key word set up in a portion of a string corresponding to the command with content data for specifying a content of process corresponding to the command, comprising:
a display step of generating display data for displaying a keyword to be uttered by the user and supplying these to a display apparatus;
a voice recognition step of specifying an input command corresponding to the voice uttered on the basis of the dictionary data in a case where the voice uttered by the user is inputted in accordance with screen image displayed on the display apparatus; and
an execution step of carrying out a process corresponding to the input command thus specified on the basis of the content data,
wherein the keyword in the dictionary data is set up within a range of number of characters enabled to display with the display apparatus, and
in the display step, the display data are generated in the range of number of characters enabled to display and supplied to the display apparatus.

14. A dictionary data generation program for generating dictionary data for voice recognition, used in a voice recognition apparatus which recognizes an input command by a user on the basis of a voice uttered by the user using a computer, comprising:
an acquisition device that acquires text data corresponding to the command;
a specification device that specifies number of characters of a keyword for voice recognition, which can be displayed by a display apparatus for displaying the keyword;
a set-up device that extracts a part of string within a range of number of characters thus specified out of each text data thus acquired and setting up the string as the keyword; and
a generation device that generates feature quantity data indicative of feature quantity of a voice corresponding to the keyword thus set up and the dictionary data by associating content data for specifying content of process corresponding to the command with the feature quantity data.

15. A processing program for executing a process in a computer including a record device that records dictionary data associating feature quantity data indicative of feature quantity data corresponding to a keyword set up in a portion of a string corresponding to a command and content data for specifying content of process corresponding to the command;
and a voice recognition apparatus for recognizing an input command corresponding to a voice uttered by a user in use of the dictionary data, which causes the computer to function as:
a display device that generates display data for displaying a keyword to be uttered by a user on the basis of the dictionary data and supplying it to the display apparatus;
a voice recognition device that specifies an input command corresponding to the voice uttered on the basis of the dictionary data in a case where the voice uttered by the user is inputted in accordance with a screen image displayed on the display apparatus; and
an execution device that executes a process corresponding to the input command thus specified on the basis of the content data,
wherein the keyword in the dictionary data is set up in a range enabled to display with the display apparatus which displays the keyword, and
the computer as the display apparatus is caused to function to generate the display data in the range of number of characters enabled to display and supply to the display apparatus.

16. An information recording medium having the dictionary data generation program according to claim 14 recorded on it.

17. An information recording medium having the processing program according to claim 15 recorded on it.
